(19) United States
(12) Patent Application Publication
(10) Pub. No.: US 2014/0034700 A1
(43) Pub. Date: Feb. 6, 2014

(54) NAIL GUN CAPABLE OF PREVENTING ITS TRIGGER FROM BEING PULLED IN NAIL-EMPTY CONDITION

(71) Applicant: Chin-Chin Chang, Taichung City (TW)

(72) Inventor: Chin-Chin Chang, Taichung City (TW)

(21) Appl. No.: 13/567,911

(22) Filed: Aug. 6, 2012

(51) Int. Cl. B25C 1/00

(52) U.S. Cl. 227/8

(57) ABSTRACT

A nail gun capable of preventing a trigger from being pulled in a nail-empty condition is provided. The nail gun includes a housing connected with a trigger, a muzzle, a nail driving member moveably mounted in the muzzle and a nail magazine communicated with the muzzle for accommodating nails and a nail pushing member for pushing the nails toward the muzzle, and a side of the nail pushing member has a locking portion; and a safety member moveably mounted to the muzzle for upward or downward movement. An end of the safety member has a stop portion. A position of the locking portion is corresponding to that of the stop portion for selectively stopping the upward or downward movement of the safety member.

### BACKGROUND OF THE INVENTION

1. Field of the Invention

The present invention relates generally to nail guns and more particularly, to a nail gun capable of preventing its trigger from being pulled in a nail-empty condition where there isn't any nail in the nail magazine and the muzzle of the nail gun.

2. Description of Related Art

To prevent a nail gun from damage while none of any nails is available in the nail gun and a user still fires the nail gun, the nail gun is usually equipped with a safe firing mechanism.

U.S. Pub. No. 2011/0240710 A1 disclosed a nail gun including a rotatable shaft which can lock a switch of a trigger of the nail gun in a nail-empty condition. The rotatable shaft has a locking portion and a driven portion extending partly into a nail magazine, such that when a nail pushing member disposed in the nail magazine reaches a predetermined position, the nail pushing member pushes the driven portion to make the rotatable shaft rotate about an axis perpendicular to a marching direction of the nails loaded in the nail magazine. As a result, the locking portion of the rotatable shaft in an initial position and spaced away from the switch will move to a locking position to be engaged with the switch. Therefore, the nail gun can shoot nails continuously until there is totally no nail in the nail gun and the nail gun is locked.

However, the rotatable shaft has to be designed accurately to be engaged with the switch successfully.

Notwithstanding the prior art, the invention is neither taught nor rendered obvious thereby.

### SUMMARY OF THE INVENTION

It is a primary objective of the present invention to overcome the shortcomings of the prior art by utilizing the corresponding relationship of the locking portion and the stop portion for preventing its trigger from being pulled in a nail-empty condition.

To achieve the foregoing objective, the present invention provides a nail gun capable of preventing its trigger from being pulled in a nail-empty condition, comprising a housing connected with a trigger, a muzzle, a nail driving member moveably mounted in the muzzle and a nail magazine communicated with the muzzle for accommodating nails and a nail pushing member for pushing the nails toward the muzzle, and a side of the nail pushing member has a locking portion; and a safety member moveably mounted to the muzzle for upward or downward movement, wherein an end of the safety member has a stop portion; wherein a position of the locking portion is corresponding to that of the stop portion for selectively stopping the upward or downward movement of the safety member.

Preferably, the safety member further comprises a reset piece, wherein the reset piece provides a recover force to the safety member back to an original position when the safety member is moved away by a force.

Preferably, the position of the stop portion is below that of the locking portion for stopping the upward movement of the safety member when the safety member is located at the original position and the nail pushing member stops against the safety member.

Preferably, the safety member moves away from the muzzle when the safety member is moved from the original position by the force.

Preferably, the safety member is partially projected over the muzzle.

Preferably, the nail pushing further comprises an elastic member for pushing the nails toward the muzzle.

In summation of the description above, the nail gun capable of preventing a trigger from being pulled in a nail-empty condition of the present invention have one or more of the following advantages:

When the nails do not exist in the nail magazine, the stop portion of the safety member will be stopped against the locking portion of the nail pushing member. Therefore, the trigger would not be pulled because of the safety member cannot be moved upward or downward freely.

The above and other objects, features and advantages of the invention will become apparent from the following detailed description taken with the accompanying drawings.

### BRIEF DESCRIPTION OF THE DRAWINGS

FIG. 1 is a schematic view of a nail gun capable of preventing a trigger from being pulled in a nail-empty condition of a first embodiment of the present invention;

FIG. 2 is a schematic view of the nail magazine and a safety member of the first embodiment of the present invention;

FIG. 3A is a schematic view of the stop portion being below that of the locking portion when the safety member is located at the original position and the nail pushing member stops against the safety member of the first embodiment of the present invention;

FIG. 3B is a schematic view of the safety member being away from the original position by a force of the first embodiment of the present invention;

FIG. 3C is a schematic view of the safety member not moved by the force and being located at the original position and the nail pushing member without stopping against the safety member of the first embodiment of the present invention;

FIG. 4A is an expanded view of a portion of FIG. 3A, showing preventing a trigger from being pulled of the first embodiment of the present invention;

FIG. 4B is an expanded view of a portion of FIG. 3B, showing that the safety member stops against the work piece of the first embodiment of the present invention;

FIG. 4C is an expanded view of a portion of FIG. 3C, showing that the safety member does not stop against the work piece of the first embodiment of the present invention;

FIG. 5 is a schematic view similar to FIG. 4B, showing nails in the nail magazine of the first embodiment of the present invention;

FIG. 6 is a cross-sectional view of the nail gun of the first embodiment of the present invention;

FIG. 7 is an expanded view of a portion of FIG. 6, showing the nail gun of the first embodiment of the present invention;

FIG. 8 is a cross-sectional view similar to 7, showing that the safety member stops against the work piece of the first embodiment of the present invention;

FIG. 9 is a schematic view of the nail magazine and a safety member of a second embodiment of the present invention;

FIG. 10 is a schematic view of the stop portion being below that of the locking portion when the safety member is located at the original position and the nail pushing member stops against the safety member of the second embodiment of the present invention;

FIG. 11 is a schematic view of the safety member being located at the original position and the nail pushing member without stopping against the safety member of the second embodiment of the present invention;

FIG. 12 is a schematic view of the nail magazine and a safety member of a third embodiment of the present invention;

FIG. 13 is a schematic view of the stop portion being below that of the locking portion when the safety member is located at the original position and the nail pushing member stops against the safety member of the third embodiment of the present invention;

FIG. 14A is a schematic view of the safety member being located at the original position and the nail pushing member pushing the U-shaped nails of the third embodiment of the present invention; and

FIG. 14B is a schematic view of the safety member being located at the original position and the nail pushing member without stopping against the safety member of the third embodiment of the present invention.

### DETAILED DESCRIPTION OF THE INVENTION

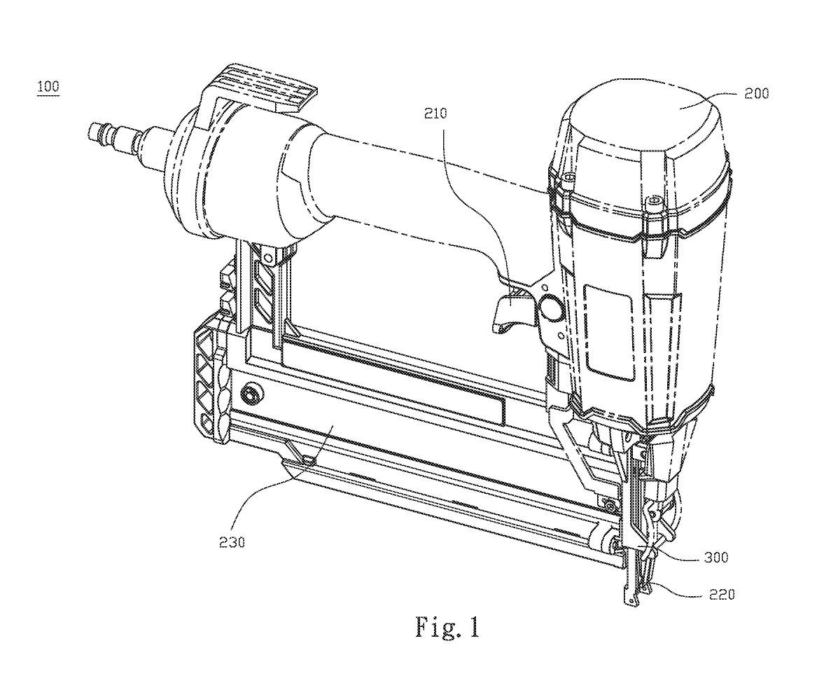

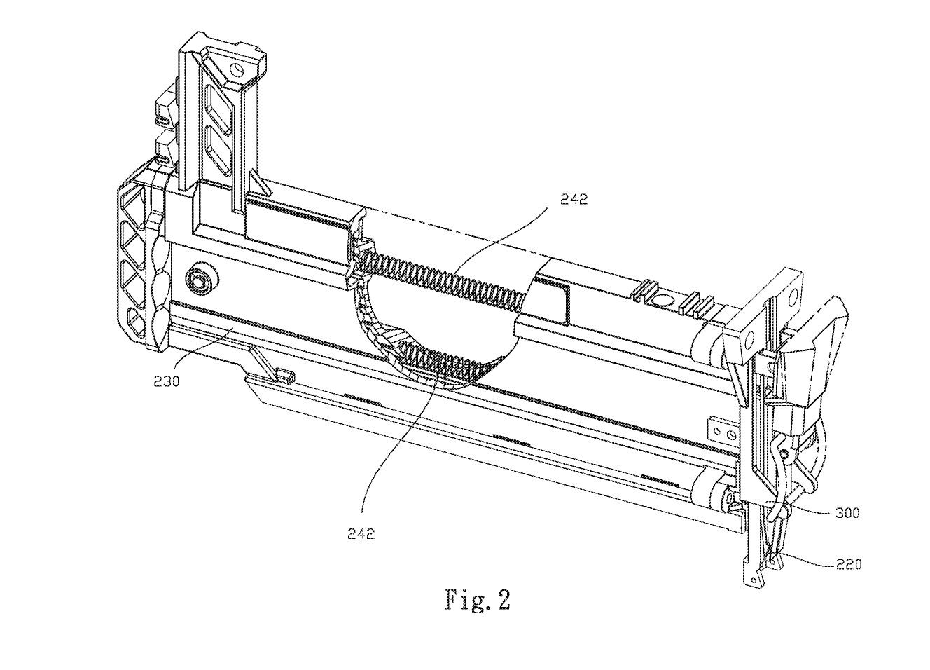

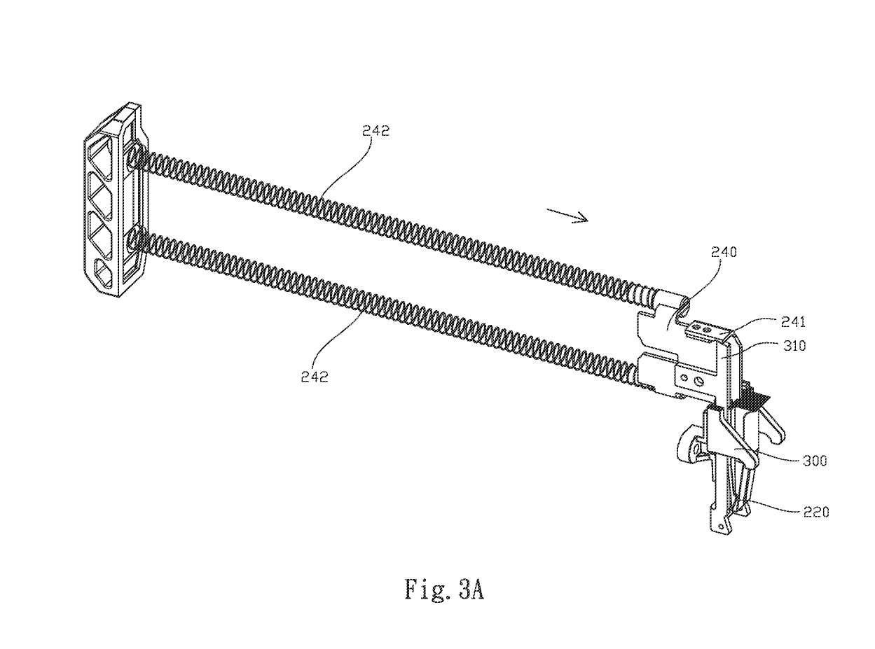

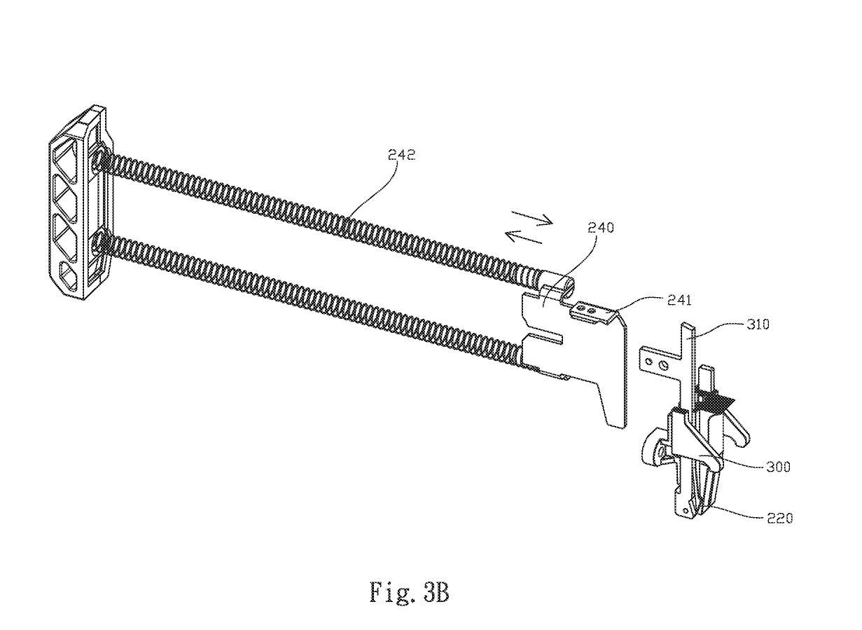

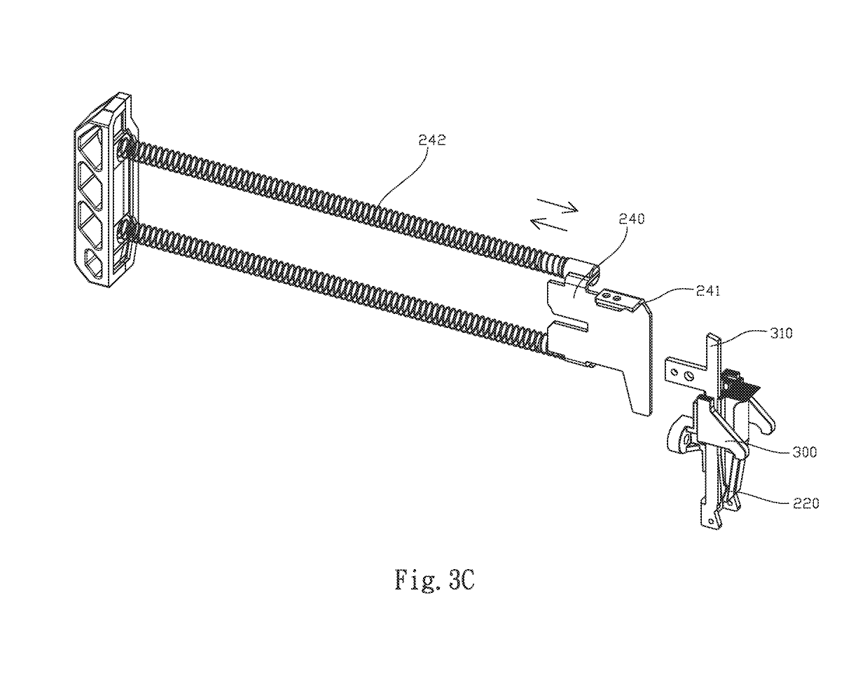

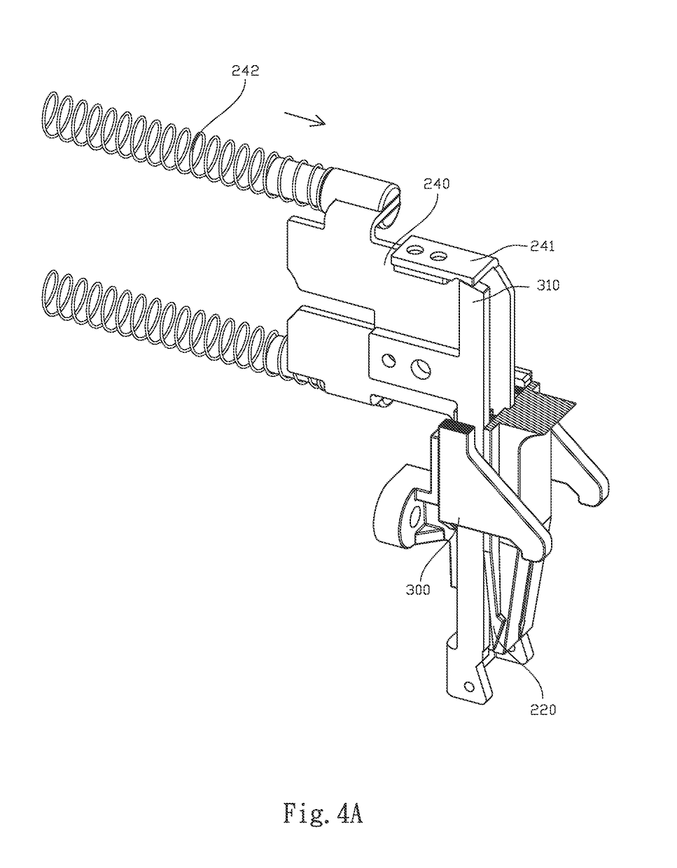

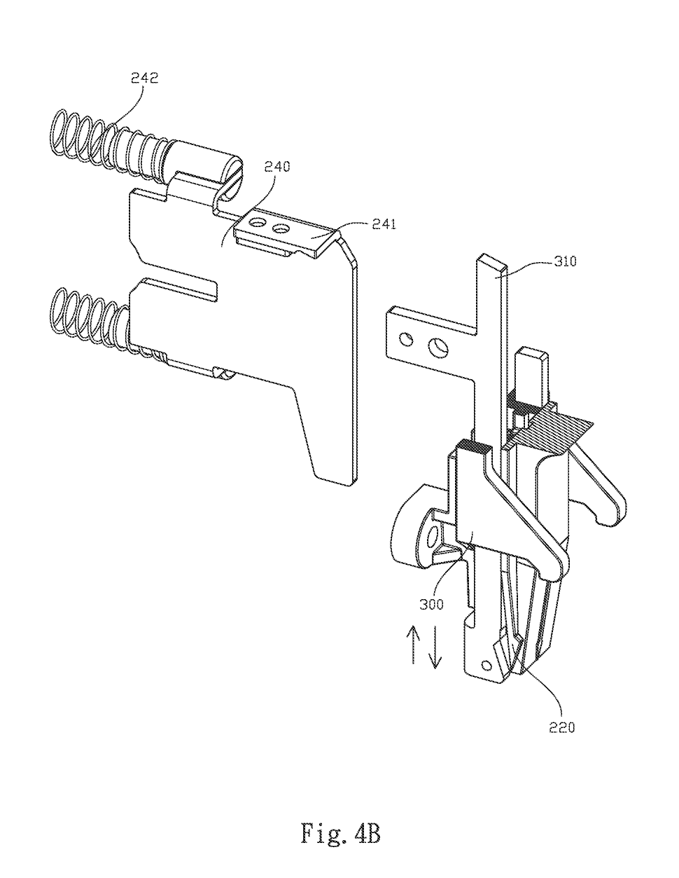

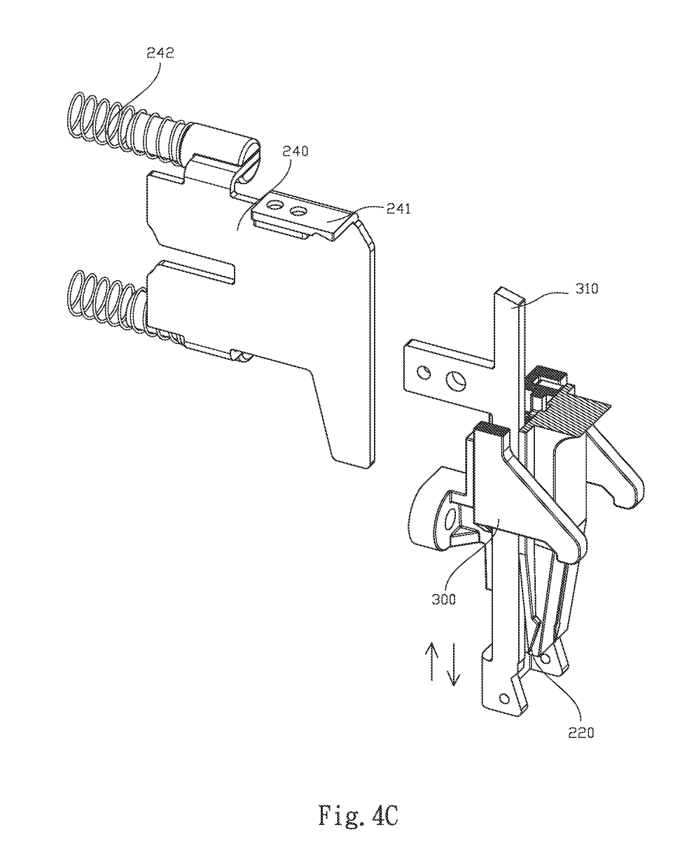

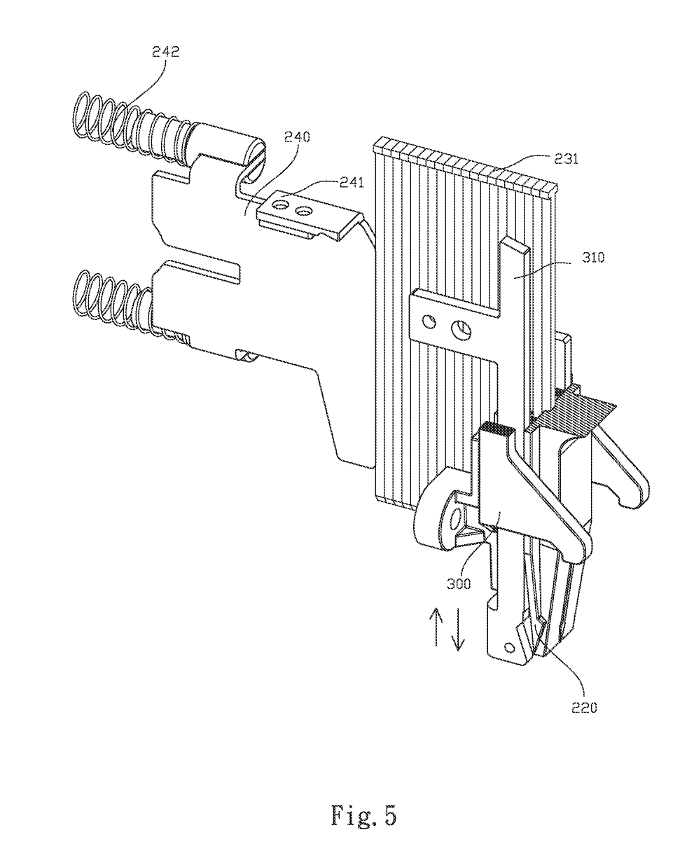

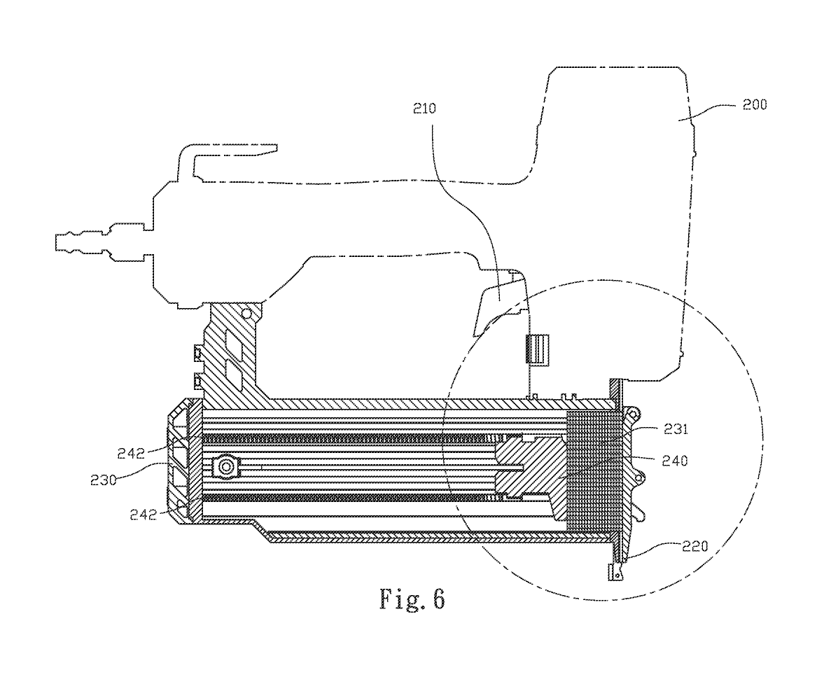

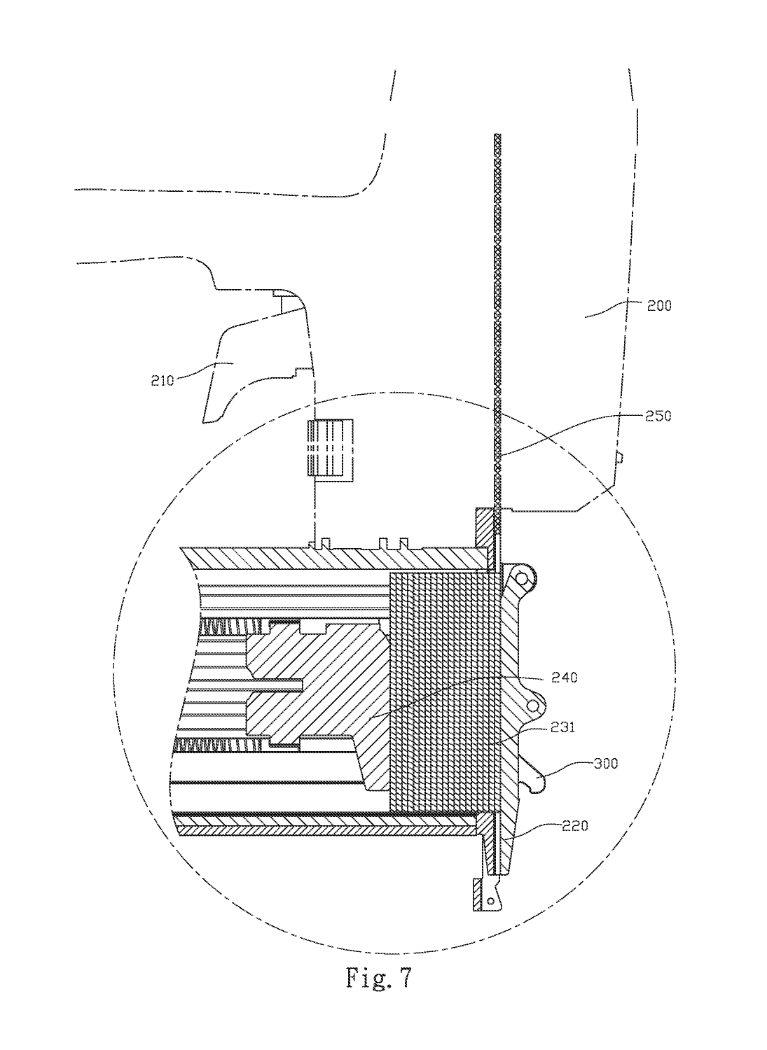

Referring to FIGS. 1-8, a nail gun 100 according to a first preferred embodiment of the present invention includes a housing 200 and a safety member 300. Specifically, the housing 200 is connected with a trigger 210, a muzzle 220, a nail driving member 250 moveably mounted in the muzzle 220 and a nail magazine 230 communicated with the muzzle 220 for accommodating nails 231 and a nail pushing member 240 for pushing the nails 231 toward the muzzle 220, and a side of the nail pushing member 240 has a locking portion 241. Alternatively, the nail pushing member 240 further comprises an elastic member 242 for pushing the nails 231 toward the muzzle 220.

Alternatively, the safety member 300 moveably mounted to the muzzle 220 for upward or downward movement, wherein an end of the safety member 300 has a stop portion 310. In details, when there are nails 231 in the nail magazine 230, the locking portion 241 of the nail pushing member 240 will not stock the stop portion 310 of the safety member 300. Namely, the safety member 300 moves upward or downward without resist. However, if there is no nail 231 in the nail magazine 230, which means a nail-empty condition, the nail pushing member 240 will stop against the safety member 300 and the locking portion 241 will stock the stop portion 310 of the safety member 300. In the first preferred embodiment of the present invention, the position of the stop portion 310 is below that of the locking portion 241 for stopping the upward movement of the safety member 300. In other words, the nail gun capable of preventing a trigger 210 from being pulled in a nail-empty condition of the invention effectively prevents nail gun from damage when the trigger 210 is pulled in a nail-empty condition.

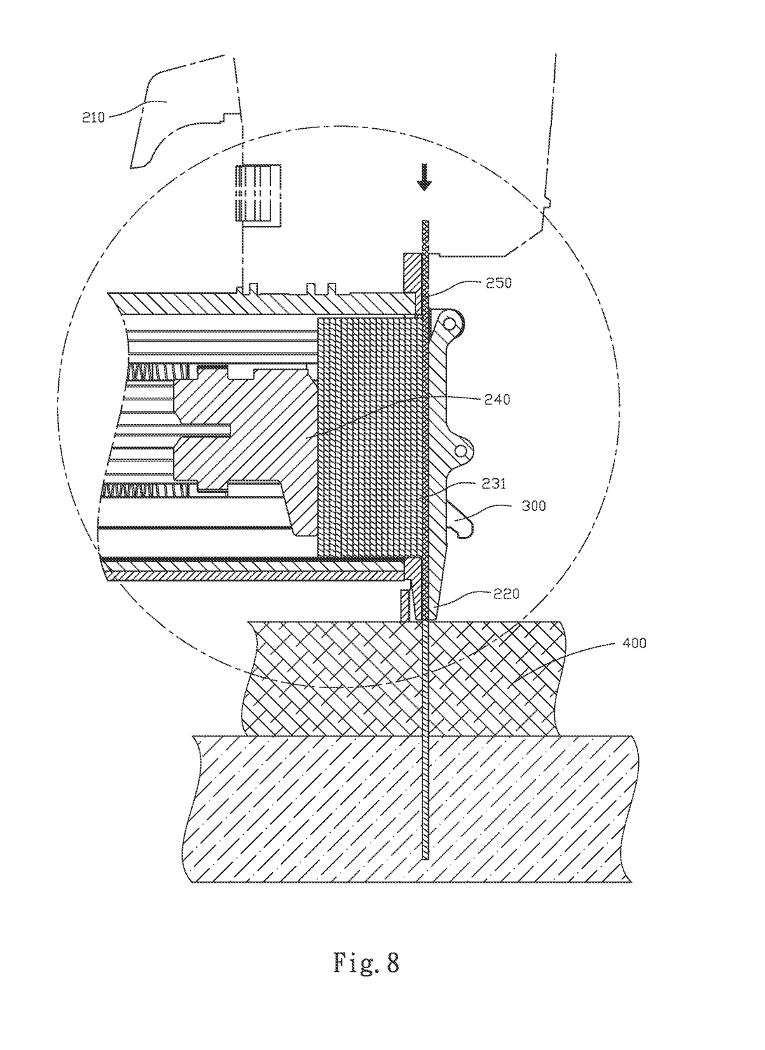

Alternatively, the safety member 300 is advantage of avoiding the trigger 210 being pulled mistakenly. Preferably, the safety member 300 further comprises a reset piece (not shown), wherein the reset piece provides a recover force to the safety member 300 back to an original position when the safety member 300 is moved away by a force. In details, the safety member 300 will keep at the original position in a non-force condition. Preferably, a part of the safety member 300 is projected over the muzzle 220. When a user utilizes the nail gun of the invention, the muzzle 220 has to stop against a work piece 400 (see FIG. 8). Therefore, it is easily to understand that the safety member 300 will move away from the orientation of the muzzle 220 by the force of stopping against a work piece, wherein the safety member 300 preferably utilizes a linkage (not shown) connects to the trigger 210 or nail driving member 250. If a moving distance of the safety member 300 away from the muzzle 220 is not enough, the nail driving member 250 would not hit the nails 231 when the trigger 210 is pulled. Therefore, the trigger 210 being pulled mistakenly can be avoided.

Similarly, in the first preferred embodiment, if the nail gun of the invention is in a nail-empty condition, the position of the stop portion 310 is below that of the locking portion 241 for stopping the upward movement of the safety member 300. Namely, the moving distance of the safety member 300 away from the muzzle 220 is not enough, the nail driving member 250 would not hit the nails 230 when the trigger 210 is pulled. Therefore, the trigger 210 which is pulled in a nail-empty condition is avoided.

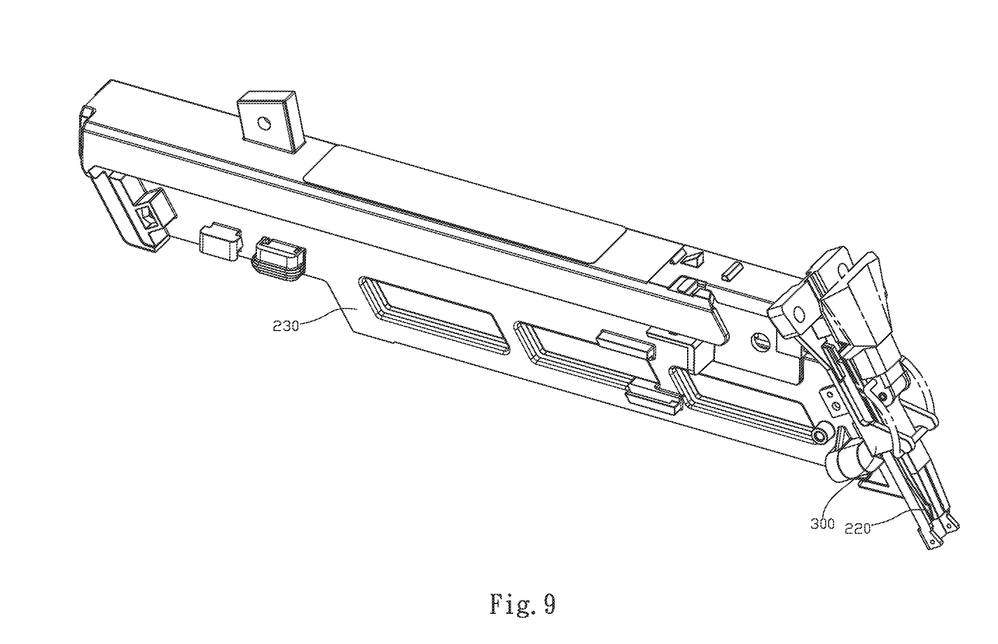

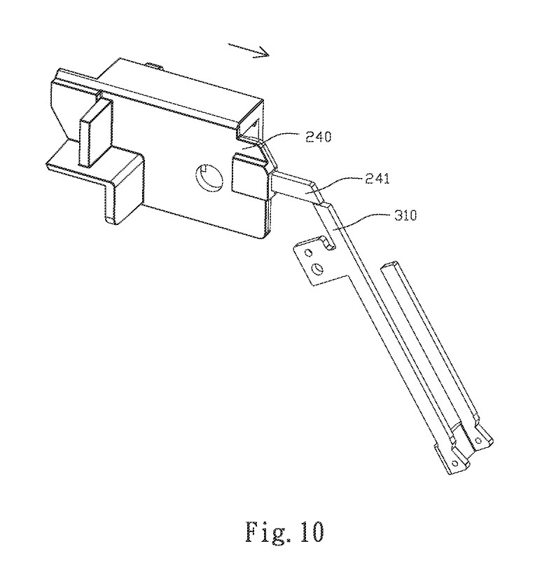

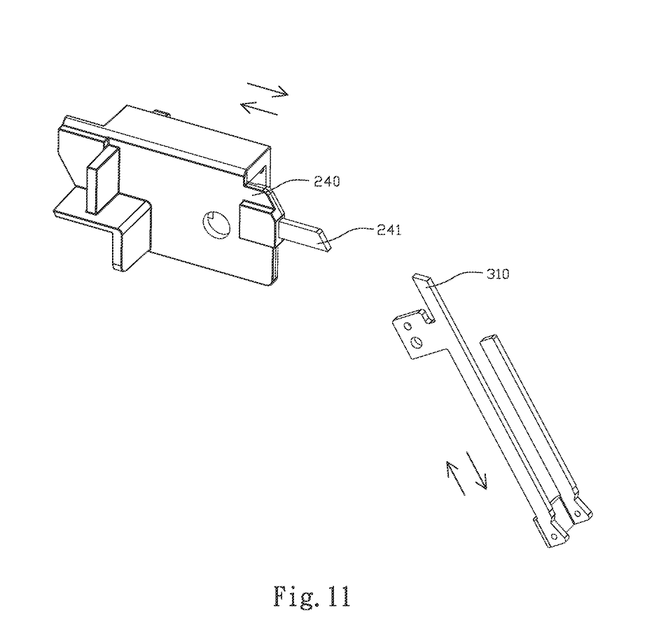

Referring to FIGS. 9-11, a nail magazine for accommodating oblique nails according to a second preferred embodiment of the invention is shown. The principle of the second preferred embodiment is like that of the first preferred embodiment, wherein an oblique angle is between the stop portion 310 of the safety member 300 and the locking portion 241 of the nail pushing member 240. When the safety member 300 is at the original position, the position of the stop portion 310 is below that of the locking portion 241. Namely, if the nail gun is in a nail-empty condition, the trigger will not be pulled because the upward movement of stop portion 310 of the safety member is stopped against the locking portion 241.

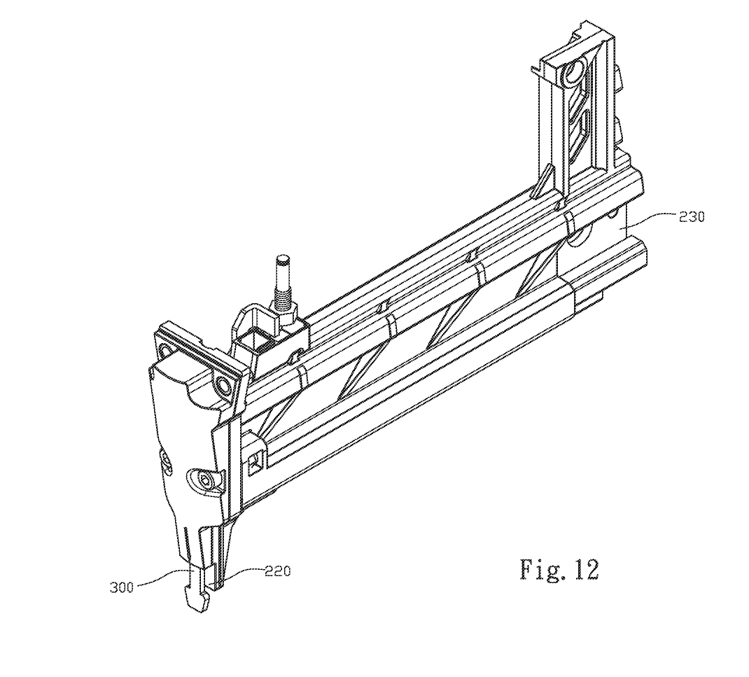

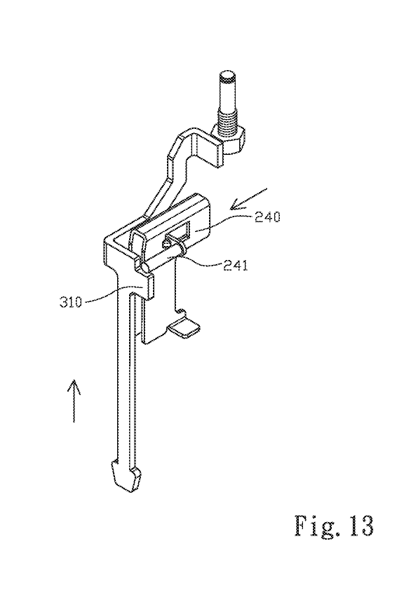

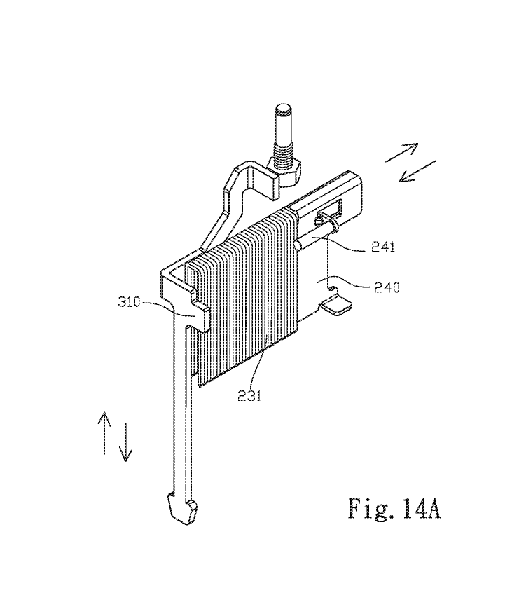

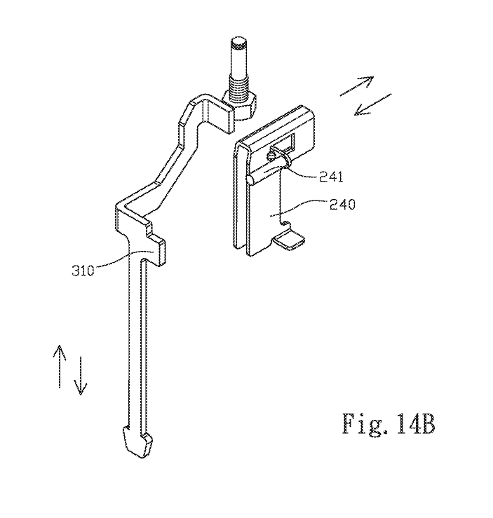

Referring to FIGS. 12-14B, a nail magazine for accommodating U-shaped nails according to a third preferred embodiment of the invention is shown. The principle of the third preferred embodiment is like that of the first preferred embodiment. When the safety member 300 is at the original position and the nail gun is in a nail-empty condition, the position of the stop portion 310 is below that of the locking portion 241 for stopping the upward movement of the safety member 300.

While the invention has been described in terms of preferred embodiments, those skilled in the art will recognize that the invention can be practiced with modifications within the spirit and scope of the appended claims.

What is claimed is:

1. A nail gun capable of preventing a trigger from being pulled in a nail-empty condition, comprising:
a housing connected with a trigger, a muzzle, a nail driving member moveably mounted in the muzzle and a nail magazine communicated with the muzzle for accommodating nails and a nail pushing member for pushing the nails toward the muzzle, and a side of the nail pushing member has a locking portion; and
a safety member moveably mounted to the muzzle for upward or downward movement;
wherein an end of the safety member has a stop portion; and
wherein a position of the locking portion is corresponding to that of the stop portion for selectively stopping the upward or downward movement of the safety member.

2. The nail gun of claim 1, wherein the safety member further comprises a reset piece, wherein the reset piece provides a recover force to the safety member back to an original position when the safety member is moved away by a force.

3. The nail gun of claim 2, wherein the position of the stop portion is below that of the locking portion for stopping the upward movement of the safety member when the safety member is located at the original position and the nail pushing member stops against the safety member.

4. The nail gun of claim 2, wherein the safety member moves away from the muzzle when the safety member is moved from the original position by the force.

5. The nail gun of claim 2, wherein the safety member is partially projected over the muzzle.

6. The nail gun of claim 1, wherein the nail pushing member further comprises an elastic member for pushing the nails toward the muzzle.
